(19) United States
(12) Patent Application Publication
(10) Pub. No.: US 2023/0304806 A1
(43) Pub. Date: Sep. 28, 2023

(54) GRAPH-BASED VEHICLE ROUTE OPTIMIZATION WITH VEHICLE CAPACITY CLUSTERING

(71) Applicant: Microsoft Technology Licensing, LLC, Redmond, WA (US)

(72) Inventors: Abir CHAKRABORTY, Bangalore (IN); Ye XING, Wellesley, MA (US); Mirco MILLETARI', Singapore (SG)

(73) Assignee: Microsoft Technology Licensing, LLC, Redmond, WA (US)

(21) Appl. No.: 17/656,871

(22) Filed: Mar. 28, 2022

(51) Int. Cl. G01C 21/34; G01C 21/36

(52) U.S. Cl. CPC G01C 21/3438; G01C 21/3469; G01C 21/3484; G01C 21/3492; G01C 21/3605

(57) ABSTRACT

A computerized vehicle route optimization system is provided, including a processor configured to receive a graph of service location nodes and edges representing a travel cost metric between the service location nodes. The processor is further configured to, for each vehicle, determine a vehicle capacity, and instantiate a route data structure storing an ordered list of service location nodes, ordered by travel order. The processor is further configured to cluster the graph into node clusters such that a total of the service weighting values of all service location nodes in each node cluster is under the vehicle capacity. The processor is further configured to populate the ordered list of each route data structure with the service location nodes in a respective cluster, and optimize, via a hybrid reinforcement learning-annealing module, the ordered list of each route data structure to minimize a total travel cost metric of the plurality of vehicles.

### BACKGROUND

Consumers and businesses alike utilize many services that require vehicles to travel to service locations and perform requested services. For example, products purchased at online shopping sites are delivered by vehicles, product returns are often picked up by vehicles, and on-premises services such as cleaning, repair, and maintenance services are often serviced by vehicles that travel to a series of service locations throughout the day. The rise of such vehicle travel has been particularly noticeable in the case of e-commerce driven deliveries and pickups. As consumers increasingly rely on e-commerce to meet their shopping needs, businesses face a greater challenge to provide timely delivery of goods and pickup of returned goods, to provide consumers with a trustworthy and convenient online shopping experience in a cost-efficient, timely, and energy-efficient manner.

### SUMMARY

To address the issued discussed herein, computerized vehicle route optimization systems and methods are provided. In one aspect, the computerized vehicle route optimization system includes a processor and associated memory storing instructions that when executed cause the processor to receive a graph of service location nodes and edges representing a travel cost metric between the service location nodes, each service location node having an associated service weighting value indicating a size, weight, or number of one or more service items associated with each service location node. The processor is further configured to, for each of a plurality of vehicles available to service the service locations, determine a vehicle capacity, and instantiate a route data structure configured to store an ordered list of service location nodes, ordered by travel order. The processor is further configured to cluster the graph into a plurality of node clusters such that a total of the service weighting values of all service location nodes in each node cluster is less than or equal to the vehicle capacity of a respective vehicle of the plurality of vehicles. The processor is further configured to populate the ordered list of each route data structure with the service location nodes in a respective cluster. The processor is further configured to optimize the ordered list of each route data structure to minimize a total travel cost metric of the plurality of vehicles, by, for each node cluster, looping for a finite number of passes through a loop, and on each pass: selecting a candidate route optimization action at each iteration of the loop according to a policy of a reinforcement learning (RL) agent; applying the selected route optimization action to the ordered list for one or more vehicles; evaluating the selected candidate route optimization action by calculating a total travel cost metric for the ordered list; and updating the policy based on the evaluation of the selected candidate route optimization action. The processor is further configured to output the optimized ordered list in the route data structure for each vehicle.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system for vehicle route optimization among a plurality of vehicles traveling to a plurality of service locations, including a clustering module configured to cluster a graph into a plurality of node clusters representing service locations, and a hybrid reinforcement learning-annealing module configured to optimize an ordered list of the service locations of each node cluster in a route data structure for each vehicle.

FIG. 2 shows a schematic view of a Markov Chain Monte Carlo (MCMC) agent of the hybrid reinforcement learning-annealing module of the system of FIG. 1, configured to evaluate a selected candidate route optimization action from a reinforcement learning (RL) agent based on an MCMC accept/reject policy, and output a reward and status update to the RL agent.

FIG. 3 shows a schematic view of an example of a clustered graph of service location nodes and edges that is clustered by the clustering module of the system of FIG. 1 using a modified clustering algorithm that includes a loss function with a loss term for vehicle capacity.

FIG. 4 shows a schematic view of an example ordered list of each route data structure that is optimized by the hybrid reinforcement learning-annealing module of the system of FIG. 1, to minimize a total travel cost metric of each vehicle by applying a selected route optimization action to the ordered list.

FIG. 5 shows a schematic view of a prophetic example of an exploration of solution space through a random walk with an exploration parameter decreasing in each of a plurality of annealing optimization loops implemented by the hybrid reinforcement learning-annealing module of the system of FIG. 1.

FIGS. 6A and 6B show a flowchart of a computerized method according to one example implementation of the computing system of FIG. 1.

FIG. 7 shows an example computing environment according to which the embodiments of the present disclosure may be implemented.

### DETAILED DESCRIPTION

To address the challenges discussed above, businesses have attempted to develop vehicle route optimization technologies to improve delivery operations for better timeliness, efficiency, cost-effectiveness, and reduced energy consumption. Such technologies include vehicle route optimization software that implements algorithms for scheduling deliveries made by a fleet of vehicles. Computing optimized vehicle routes is a combinatorial optimization problem that is classified as Non-deterministic Polynomial-time hard (NP-hard). It will be appreciated that a single e-commerce distribution center may service many thousands of packages going to many thousands of customer locations in a single day. In such a busy environment, conventional route scheduling software is forced to trade off accuracy in optimization to speed up computation time. As a result, the software often outputs routes that are not sufficiently optimized, resulting in wasted cost, distance traveled, and energy consumed as compared to the ideal routing solution.

To address this issue, a computerized vehicle route optimization system is disclosed herein that can speed up the overall computation time for route optimization, which has the potential benefit of making improved route optimizations available in sufficient time for daily adoption even at busy e-commerce distribution centers. The system accounts for vehicle capacity, thus avoiding calculating routes that would put a vehicle over its capacity. The system accounts for vehicle capacity by clustering a graph of service location nodes into clusters such that service weighting values, which represent the vehicle capacity taken by service items, of all service location nodes in each node cluster are under the vehicle capacity of the service vehicles. After clustering, the system optimizes the routes on a cluster-by-cluster basis using a hybrid reinforcement learning-annealing approach, to minimize a travel cost metric associated with the routes, as discussed in detail below. As used herein, the term minimize refers to the process of seeking to find an estimate of a solution with a reduced cost and will not necessarily result in a global or absolute minimized solution.

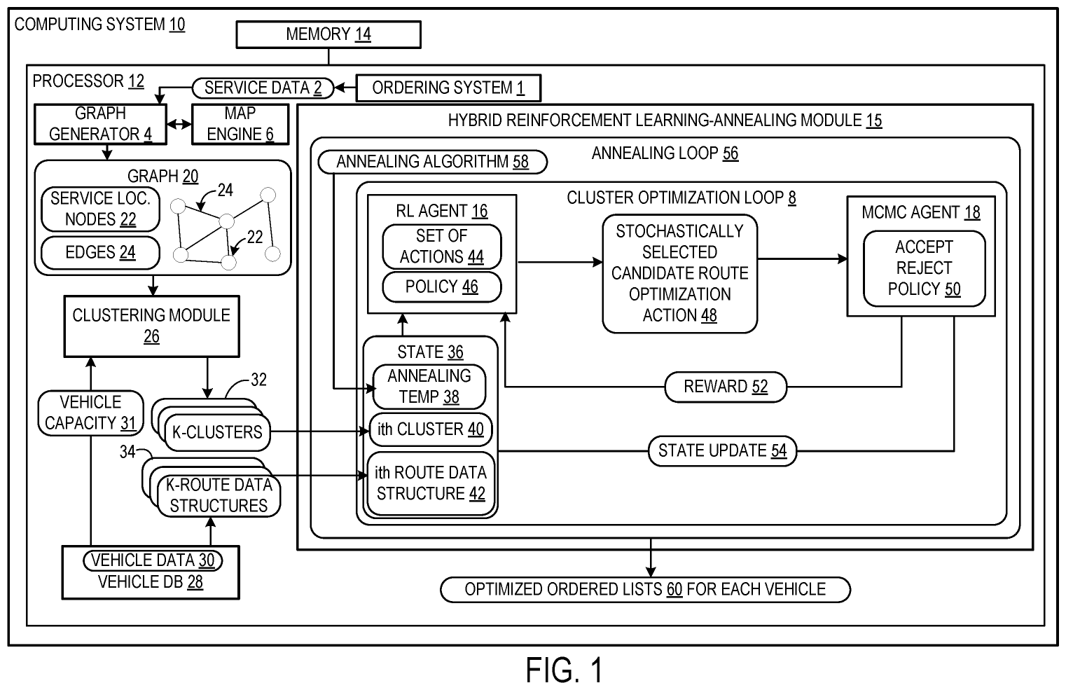

FIG. 1 shows a schematic view of a computing system 10 for vehicle route optimization. The computing system 10 may include one or more processors 12 having associated memory 14 and may be configured to execute instructions using portions of memory 14 to perform the functions and processes of the computing system 10 described herein. For example, the computing system 10 may include a cloud server platform including a plurality of server devices, and the one or more processors 12 may be one processor of a single server device, or multiple processors of multiple server devices. The computer system 10 may also include one or more client devices in communication with the server devices, and one or more of processors 12 may be situated in such a client device. Below, the functions of computing system 10 as executed by processor 12 are described by way of example, and this description shall be understood to include execution on one or more processors distributed among one or more of the devices discussed above.

Computing system 10 is configured to perform vehicle route optimization among a plurality of vehicles traveling to a plurality of service locations. Initially, the computing system 10 identifies a plurality of service locations to which a plurality of vehicles in a vehicle fleet will travel. This may be accomplished, for example, by ordering system 1 outputting service data 2 including a list of service locations to be serviced within a delivery time window from a service depot. A graph generator 4 is provided to receive the service data with the list of service locations, and create a graph 20 of service location nodes 22 and edges 24 connecting each service location node to every other service location node 22, in a fully connected manner. The graph generator 4 may determine a value for the edges 24 between each pair of service location nodes 22 in the graph 20 by querying a map engine 6 and receiving an estimated travel cost metric such as distance, travel time, or energy consumption for vehicle travel between the pair of service location nodes 22. A vehicle database 28 may be provided that includes vehicle data 30 including information on each vehicle available for travel from the service depot to the service locations, including the vehicle capacity 31 of each vehicle. The vehicle capacities 31 are used in the clustering by clustering module 26, as described below.

To achieve route optimization, processor 12 is configured to execute a clustering module 26 and a hybrid reinforcement learning (RL)-annealing module 15. The clustering module 26 performs pre-processing on graph 20 to generate a plurality of node clusters representing service locations, based upon the vehicle capacity data 31. The node clusters are passed as input to the hybrid RL-annealing module 15 for route-optimization within each cluster 40. The hybrid RL-annealing module 15 outputs an optimized ordered list 60 of the service locations of each node cluster 40 for each vehicle, as described in detail below.

Clustering module 26 executed by processor 12 of the computing system 10 is configured to receive the graph 20 of service location nodes 22 and edges 24 representing the travel cost metric between the service location nodes 22, in which each service location node 22 has an associated service weighting value indicating a size, weight, or number of one or more service items associated with each service location node 22. Service items may include delivery packages, return packages, or maintenance equipment such as a carpet cleaning machine, furnace filter, copy machine toner, or other spare part, as some examples. Each of these items occupies space in a vehicle. The service weighting value is a number that is based on the size, weight, or number of the items. For example, a van may be configured to carry 50 small packages and 10 large packages. Or, a van may be configured to carry up to 100 cubic feet of items. Or, the item size may be limited by the application, and a van may be configured to carry 150 packages of a standard size. Further, a function may be employed to calculate a service weighting metric based on these factors, such as a sum of normalized values for the size and weight, with the normalization being on the basis of the maximum allowed size and weight, and the vehicle capacity may also be computed based on the same function.

The travel cost metric may include travel distance, travel time, carbon footprint, and/or travel cost. A function may be provided that computes the travel cost metric based on these parameters. For example, a weighted sum of travel distance and travel time may be used. Travel cost, it will be appreciated, may be based on labor costs, fuel/energy costs, and vehicle wear and tear costs on a per-mile basis. The graph 20 may be created by the computing system 10 or another computing device and transmitted to the computing system 10, based on real-world data of the service locations to which deliveries need to be scheduled, and information on the fleet of vehicles that that can perform the deliveries, as described above.

The graph 20 is defined by a list of the service location nodes 22 which can store one or more properties of each node (such as the number, weight, or size of items to be delivered or picked up at the location), and a list of the edges 24 that connect pairs of two service location nodes 22. The service location nodes 22 represent locations at which a service is to be performed by the vehicle 30. The service may include, for instance, delivery, pick-up, and maintenance of an on-premises item or fixture. Maintenance means upkeep and repair of such items and fixtures. Furthermore, each service location node 22 further may include an associated node parameter indicating a delivery time window within which one of the vehicles is to arrive to perform the service. The service locations may each have a corresponding service address, which is a physical address, and the physical addresses may be resolvable on a computerized road map of the map engine 6. The values for the edges 24 of the graph 20 may be computed by determining the travel cost metric factoring the time, distance, carbon footprint, and or travel cost to travel from one node to another in the set of nodes via roads on the road map. Typically, the graph 20 is a fully connected graph, and for every node there is a route to every other node, as confirmed via the road map of the map engine 6.

As briefly discussed above, the computing system 10 further includes a vehicle database 28 storing vehicle data 30 for a plurality of vehicles available to service the service location nodes 22. The processor 12 is configured to determine, for example, by querying the vehicle database 28, a vehicle capacity 31 for each of the plurality of vehicles indicated in the vehicle data 30 as available to service the service location nodes 22, and instantiate a route data structure 34 configured to store an ordered list of service location nodes 22, ordered by travel order. The route data structure 34 may be an array of the service location nodes 22. The vehicle capacity 31 may be based on the size, weight, or number of items. Specifically, the vehicle capacity can be expressed in terms of the size, weight, or number of items, or can be computed using a function that takes into account one or more of these factors. The vehicle capacity is provided to the clustering module 26 along with other relevant vehicle data 30, such as the total number of available vehicles.

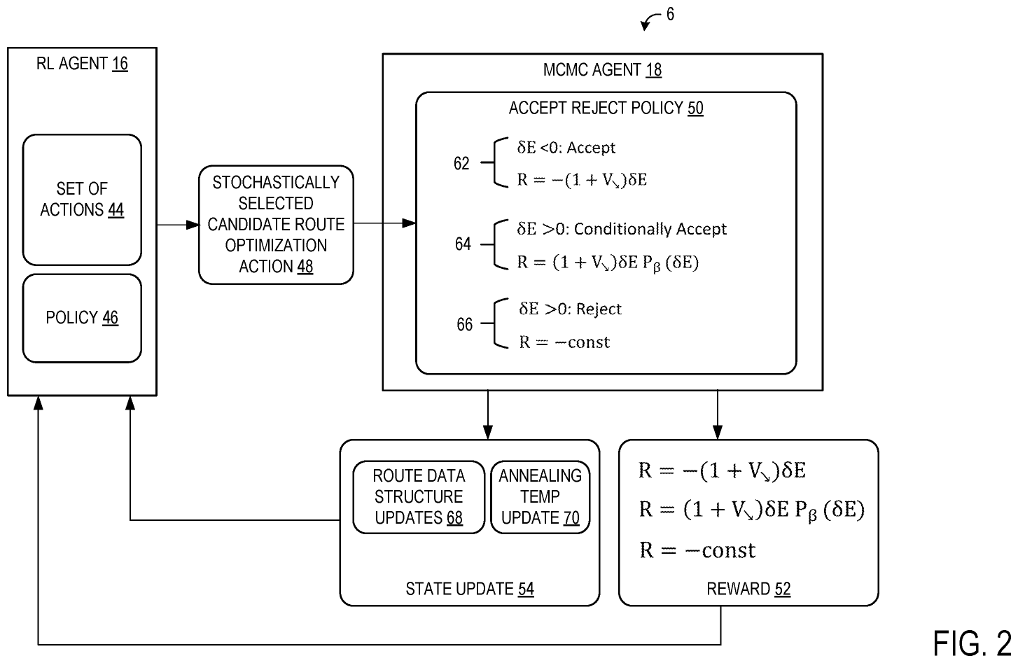

The clustering module 26 executed by the processor 12 clusters the graph 20 into a plurality of node clusters 32 such that a total of the service weighting values of all service location nodes 22 in each node cluster 32 is less than or equal to the vehicle capacity 31 of a respective vehicle of the plurality of vehicles 30, which may be allocated to service the node cluster 32. The graph 20 may be clustered by the clustering module 26 using a clustering algorithm that includes a loss function with a loss term for the vehicle capacity 31. The clustering algorithm may be a modified version of a MinCutPool algorithm, in which the loss function further includes loss term for cut loss and loss term for orthogonality loss among the clusters, as discussed in detail below with reference to FIG. 2. This graph-based clustering approach has the potential technical benefit that the system can substantially speed up the overall computation for vehicle route optimization by dividing a large-scale routing problem into smaller clusters and optimizing for each cluster, without wasting computation on clusters that represent too many packages that would overburden an associated delivery vehicle. By speeding up computation, gains in efficiency can be realized as more optimized routes can be computed in sufficient time so as to schedule vehicles with the optimized routes on a daily or per-shift basis.

Following clustering and continuing with FIG. 1, the processor 12, via the hybrid RL-annealing module 15, is configured to execute two nested loops, a first outer loop referred to as an annealing loop 56, within which a second inner loop, referred to as a cluster optimization loop 8 is performed. The annealing loop 56 controls an exploration parameter for the cluster optimization loops 8, according to a simulated annealing algorithm 58, as discussed below. On each pass of the annealing loop 56 the processor 12 is configured to determine a value for an annealing temperature 38 according to an annealing algorithm 58 that causes the annealing temperature to trend lower over time. Thus, all cluster optimization loops 8 executed during one annealing loop 56 take place at the same annealing temperature 38. Higher annealing temperatures 38 allow more exploration of a solution surface by an MCMC accept/reject policy 50 of an MCMC agent 18, while lower annealing temperatures constrain the accept/reject policy 50 of the MCMC agent 18 to only accept selected candidate route optimization actions 48 that reduce the cost function, as explained more below. This hybrid RL-annealing module 15 with nested annealing and cluster optimization loops 56, 8 has the potential technical benefit that it can improve sampling efficiency and generate a faster optimization by more quickly converging to a suitably accurate solution.

Prior to the annealing loop 56, the portion of graph 20 for i^{th} cluster 40 and the associated i^{th} route data structure 42 are read from the clusters 32 produced by the clustering module 26 and the route data structures 34 produced from the vehicle data 30. Initially, before looping through either the annealing loop 56 or the cluster optimization loop, the processor 12 is configured to populate the ordered list of each route data structure 34 with the service location nodes 22 in a respective cluster 32. The ordered lists may be initially populated with the service location nodes 22 in a random or pseudorandom travel order.

Once the ordered list in a route data structure 34 is initially populated, the processor 12, via hybrid RL-annealing module 15, is further configured to optimize the ordered list of each route data structure 34 to minimize a total travel cost metric of the plurality of vehicles 30. To optimize the ordered list of each route data structure 34, the processor, via the hybrid RL-annealing module, is further configured to execute a plurality of annealing loops 56 for each i^{th} cluster 40 of the K-clusters 34, and during each annealing loop 56, to execute a plurality of cluster optimization loops for the i^{th} cluster 40. During the cluster optimization loops 8 executed in each annealing loop 56, the MCMC agent 18 is configured to conditionally accept a selected candidate route optimization action 48 with a higher evaluated cost than a previous pass through the cluster optimization loop 8 more readily at higher annealing temperatures and less readily at lower annealing temperatures. Thus, during each annealing loop 56, the MCMC agent 18 performs the plurality of loops through the cluster optimization loop 8 for each i^{th} cluster 40 of the K-clusters 34 and each i^{th} route data structure 42 of the K-route data structures 34 for each associated vehicle at the current value for the annealing temperature 38. As the annealing temperature 38 is lowered on successive annealing loops 56, the accept/reject policy 50 of the MCMC agent 18 is further constrained to seek lower cost solutions, eventually trending toward a local minima on the solution surface. Since the RL agent 16 is rewarded in each cluster optimization loop 8 by the MCMC agent 18 for selection of candidate route optimization actions 48 that meet the goal of the policy 50, the RL agent 16 learns a policy 46 that considers each value of the annealing temperature. That is, the RL agent 16 is rewarded for exploring at higher annealing temperatures 38, and is rewarded for minimizing temperature at lower annealing temperatures 38. The policy 46 learned by the RL agent 16 is thus annealing temperature 38 specific.

Within the cluster optimization loop 8, the processor 12 is configured to, via the hybrid RL-annealing module 15, for each node cluster 34, loop for a finite number of passes through the cluster optimization loop 8, and on each pass: stochastically select the candidate route optimization action 48 at each iteration of the loop 8 according to the policy 46 of a reinforcement learning (RL) agent 16; apply the selected route optimization action to the ordered list for one or more vehicles; evaluate, via a Markov Chain Monte Carlo (MCMC) agent 18, the stochastically selected candidate route optimization action 48 from the RL agent 16 based on an MCMC accept/reject policy 50 by calculating a total travel cost metric for the ordered list; and update, via the MCMC agent 18, the RL agent policy 46 based on the evaluation of the selected candidate route optimization action 48 by sending a reward 52 to the RL agent 16. The reward 52 is chosen according to the accept/reject policy 50 of the MCMC agent 18.

In addition, within the cluster optimization loop 8, the RL agent 16 is further configured to, on each loop through the cluster optimization loop 8, receive a current state of the respective cluster 40 and route data structure 42 of the corresponding vehicle and stochastically select the selected candidate route optimization action 48 from among a predetermined set of candidate route optimization actions 44, based on a set of probabilities defined in the RL agent policy 46 for each of the set of candidate route optimization actions 44 for the state of each respective cluster and route data structure for each corresponding vehicle. Thus, while the probabilities for selection are determined by policy 46, the actual selection of the selected candidate route optimization action 48 happens randomly or pseudorandomly. The selected candidate route optimization action 48 is then passed to the MCMC agent 18 for evaluation according to the accept/reject policy 50 as described above, in a looping fashion. The number of cluster optimization loops 8 can be set aforehand by a developer, or can be determined based on the progress in the minimization of the cost function. The annealing temperature during the annealing loop can be set to decrease by a predetermined amount at each annealing loop 56, which may be linear or non-linear, or may be programmed according to a dynamic temperature generation algorithm, which can allow some brief rise in temperature even when the overall trend across the evaluation epochs is to lower the annealing temperature. The technical benefit of such an approach is to reach a reasonable level of optimization accuracy more quickly in a smaller number of computation cycles.

FIG. 2 shows a schematic view of a Markov Chain Monte Carlo (MCMC) agent 18 configured to evaluate the selected candidate route optimization action 48 from the RL agent 16 based on an MCMC accept/reject policy 50. The MCMC agent 18 is further configured to output the reward 52 and status update 54 to the RL agent 16. As described above, the candidate route optimization action 48 stochastically selected by the RL agent 16 is evaluated by the MCMC agent 18 according to the accept/reject policy 50. The action may be accepted by the MCMC agent 18 when δE<0 as shown in 62, and the action may be conditionally accepted or rejected by the MCMC agent 18 when δE>0, as shown in 64 and 66. As a result, the MCMC agent outputs the corresponding reward (R) 52 and status update 54 including route data structure updates 68 and annealing temperature update 70 to the RL agent 16 to update the RL agent policy 46.

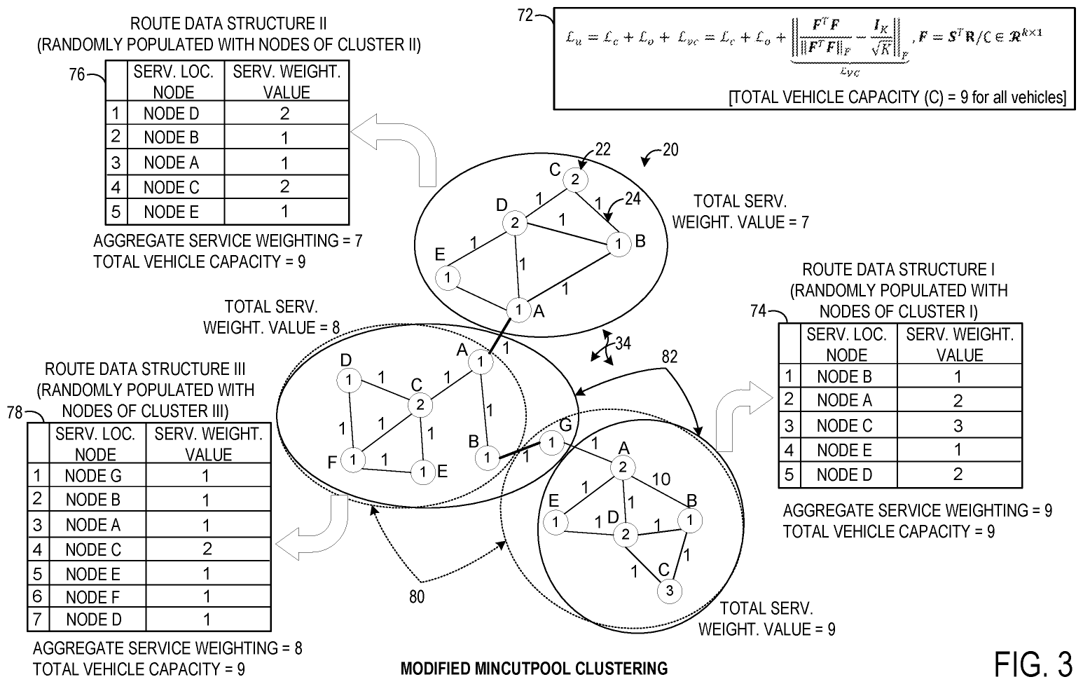

FIG. 3 shows a schematic view of an example clustered graph 20 of the service location nodes 22 and edges 24 that is clustered using the clustering module 26. The clustering module 26 may employ a modified clustering algorithm (e.g., MinCutPool) that includes a loss function with a loss term for the vehicle capacity 31. As discussed above, the modified clustering algorithm may be the modified version of a MinCutPool algorithm. MinCutPool is a graph clustering algorithm that approximates the minimum K-cut of the graph to ensure that the clusters are balanced, while also jointly optimizing the objective of the task at hand. MinCutPool utilizes a loss function 72 that includes a loss term for cut loss L_{c} and a loss term Lₒ for orthogonality loss among clusters. Moreover, the loss function 72 is modified by adding a loss term for vehicle capacity L_{vc}, where C is the vehicle capacity, S is the probability of node-i being assigned to cluster-j, R is the vector of delivery weights (which are service weighting values for deliveries), and S^{T}R is the expected weight to be delivered in each cluster. In the depicted example, the graph 20 includes the service location nodes 22 with associated service weighting values (1, 2, or 3 in this example) and edges representing a travel cost metric (1 or 10 in this example). The clustering 80 (see dotted lines) indicates that the graph 20 is clustered into three node clusters 32 using the MinCutPool algorithm without consideration of the vehicle capacity, as the total of the service weighting values of the cluster I (1+2+1+2+1+3=10) exceeds the total vehicle capacity (9). On the other hand, the clustering 82 (the solid lines) indicates that the graph 20 is clustered into three node clusters using the modified MinCutPool algorithm, which considers the vehicle capacity, as the aggregate service weighting value of the cluster I (2+1+2+1+3=9) is less than or equal to the total vehicle capacity (9). The aggregate service weighting values of the cluster II and III are also less than or equal to the total vehicle capacity (9). With the modified MinCutPool clustering, the route data structure of the node cluster I is randomly populated with the nodes of cluster I (node B, node A, node C, node E, and node D) as shown in Table 74. In the same manner, the route data structure of the node cluster II is randomly populated with the nodes of cluster II (node D, node B, node A, node C, and node E) as shown in Table 76, and the route data structure of the node cluster III is randomly populated with the nodes of cluster III (node G, node B, node A, node C, node E, node F, and node D) as shown in Table 78. Although the examples described thus far have included positive values in the vector of delivery weights R, it will be appreciated that the techniques described herein can be applied to delivery routes that also include pick-up operations, and thus can include both positive and negative values in the vector of delivery weights R. In such an example, the modified MinCutPool discussed above can be performed to cluster nodes based these delivery weights. When modified MinCutPool is applied to a hybrid route that includes both deliveries and pick-ups, the clustering can be based on a sum of the larger of the delivery weight and the absolute value of the pickup weight for each node, to account for the maximum possible load case in which the pick-ups are all scheduled prior to all deliveries. Other approaches could be alternatively used. To illustrate, in the case where node A is delivery of two packages, node B is pickup of one package, and node C is delivery of four packages and pickup of three packages, a vehicle capacity of 7 would be required to serve nodes A, B, and C in one route and without exceeding the vehicle capacity for all possible routes through these nodes. In this example, the component vector of delivery weights Rd for nodes A, B, and C would be [+2, 0, +4] and the component vector of the pickup weights Rₚ would be [0, −1, −3]. The sum of the service weighting values in this example would be the sum (=7) of the weights in the vector [2, 1, 4], which includes the larger of the delivery weight and the absolute value of the pickup weight for each node. For a route that includes only pick-ups and no deliveries, the service weighting values could be set to be positive.

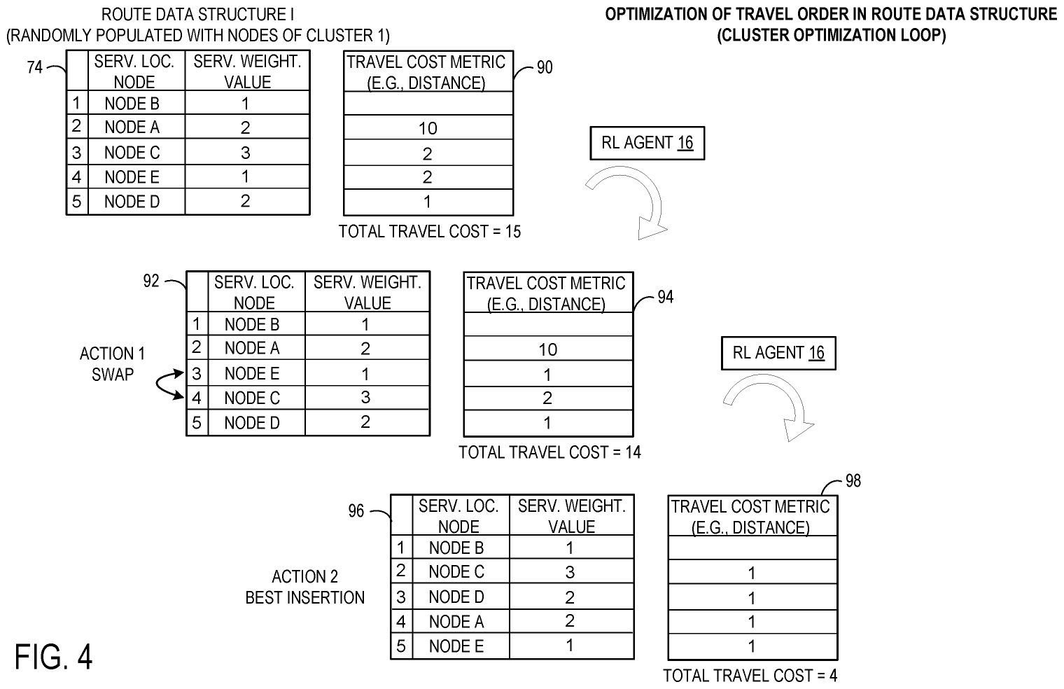

FIG. 4 shows a schematic view of an example ordered list of each route data structure that is optimized to minimize the total travel cost metric of the vehicle by applying the selected route optimization action to the ordered list. As described above, the route data structure of the node cluster I is randomly populated with the nodes of cluster I (node B, node A, node C, node E, and node D) as shown in Table 74. Further, each travel cost between the nodes (10, 2, 2, and 1) is computed and the total travel cost 15 (10+2+2+1=15) is computed as shown in Table 90. A candidate route optimization action selected via the RL agent 16 is applied to the ordered list of the route data structure I. In the depicted example, a swap action is selected and applied to the ordered list, and the order of node E and node C is swapped as shown in Table 92, and the total travel cost is reduced to 14 (10+1+2+1=14) as shown in Table 94. In the same manner, a next candidate route optimization action selected via the RL agent 16 is applied to the ordered list. In the depicted example, a best insertion action is selected and applied by the RL agent 16. The best insertion action iteratively builds a solution by inserting the cheapest node at its cheapest position; the cost of insertion is based on the global cost function of the routing model. The ordered list is changed according to the best insertion action, as shown in Table 96, and the total travel cost is further reduced to 4 (1+1+1+1=4) as shown in Table 98. It will be appreciated that other actions such as random insertion and 2-opt swap may be selected by the RL agent 16 and applied to the ordered list.

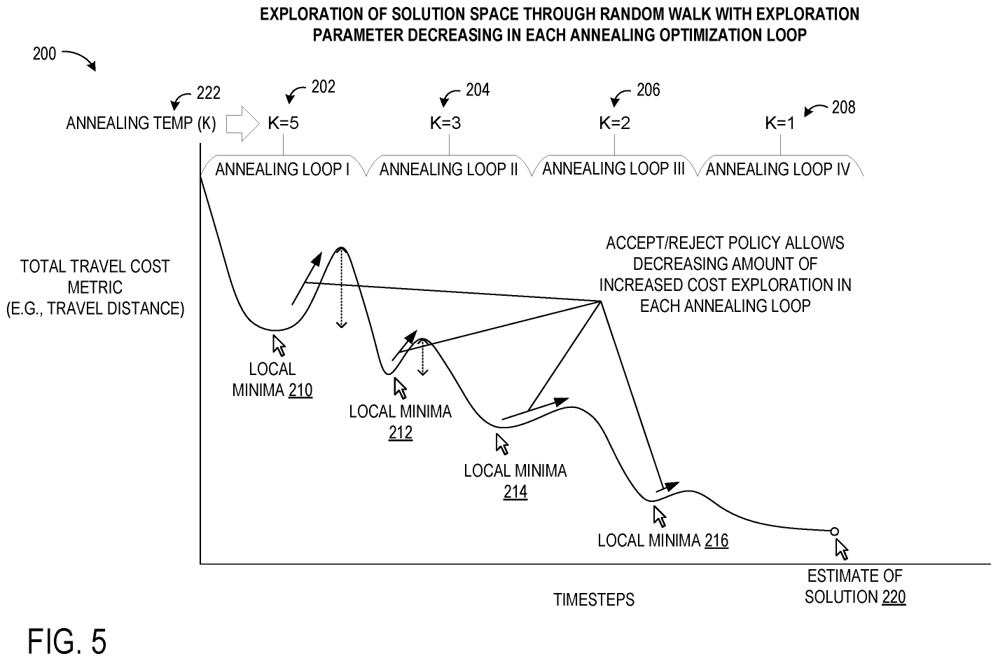

FIG. 5 shows a schematic view of an example exploration of solution space through a random walk with an exploration parameter (such as annealing temperature) decreasing in each annealing optimization loop. An example chart 200 of simulated annealing optimization loop is shown in FIG. 5. The chart 200 shows the total travel cost metric (e.g., travel distance) in relation to timesteps. In the depicted example, four annealing loops are performed, and the cluster optimization loop 8 is repeatedly performed within each of the four annealing loops at the value for the annealing temperature. For each annealing loop, a value for the annealing temperature is determined by the MCMC agent 18 according to an annealing temperature function that trends lower over time. In this example, the value for the annealing temperature (K) of the annealing loop I is set to 5, the value (K) for the annealing loop II is set to 3, the value (K) for the annealing loop III is set to 2, and the value (K) for the annealing loop IV is set to 1. The selected candidate route optimization actions 48 from the RL agent 16 are conditionally accepted by the MCMC agent 18 at the value for the annealing temperature for each annealing loop. For instance, in the annealing loop I, the selected candidate route optimization actions 48 are unconditionally accepted until a local minima 210, as the total travel cost metric decreases. On the other hand, the selected candidate route optimization actions 48 are conditionally accepted after the local minima 210 according to the value (K=5) for the annealing temperature, as the total travel cost metric increases. In the annealing loop II, the travel cost metric decreases to a local minima 212 and then increases at the value (K=3) for the annealing temperature. However, the increasing amount of the travel cost metric in the annealing loop II is less than the increasing amount of the travel cost metric in the annealing loop I since the value (K) for the annealing temperature decreases from 5 to 3. In the same manner, the increasing amount of the annealing loop III is less than that of the annealing loop II and the increasing amount of the annealing loop IV is less than that of the annealing loop III. At the end of the annealing loop IV, an estimate of solution 220, which is the lowest point of the total travel cost metric, is determined. In this manner, an optimized solution for a lowest cost route can be computed with reasonable accuracy in an efficient number of optimization steps.

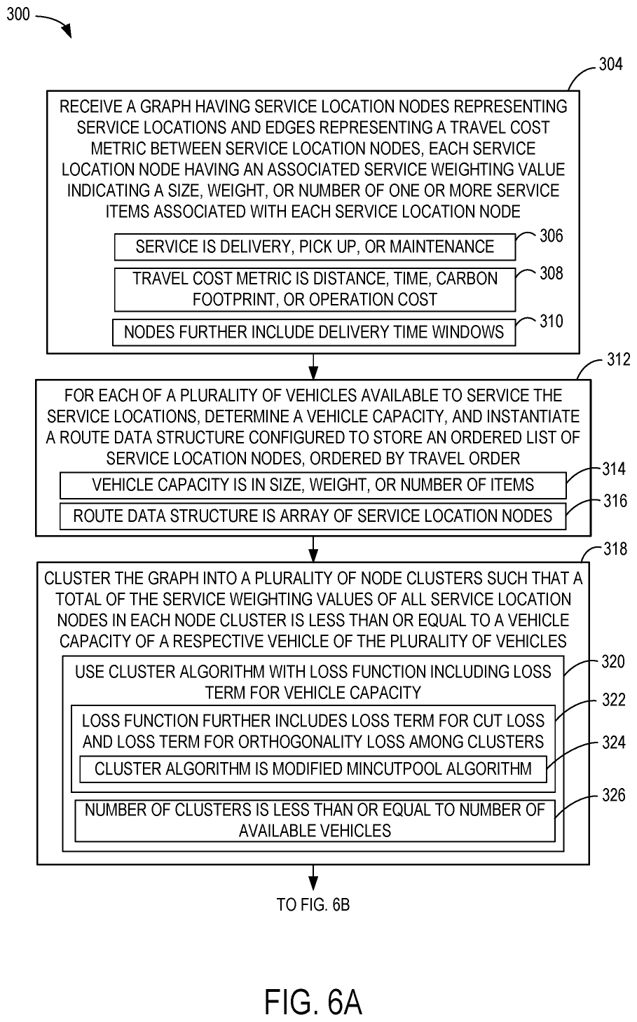

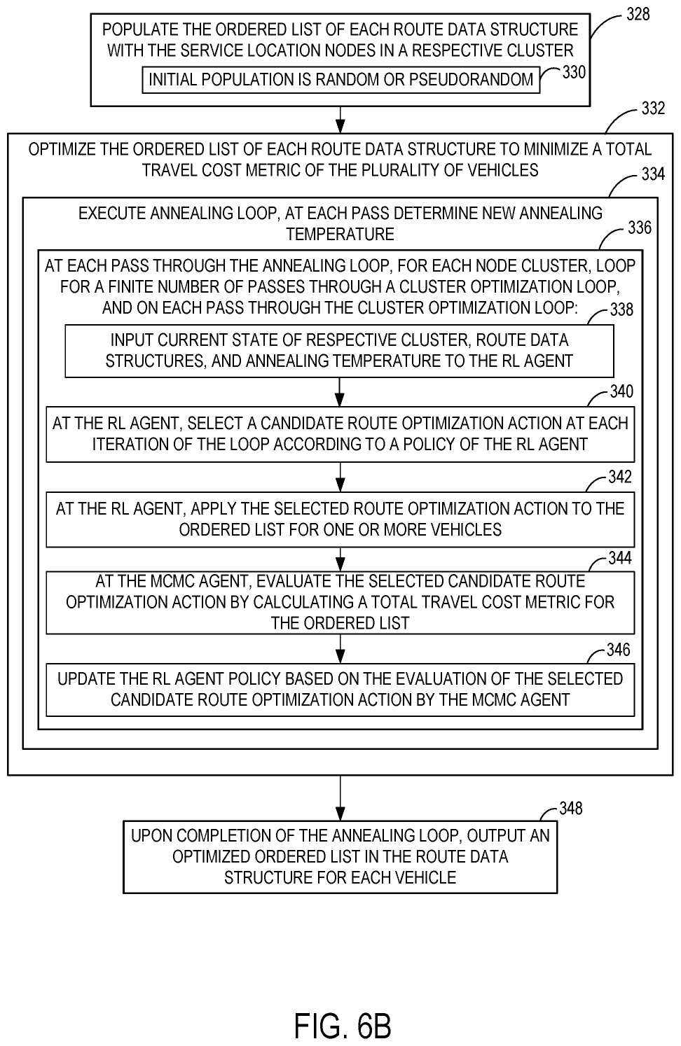

FIGS. 6A and 6B show a flowchart of a computerized method 300 according to one example implementation of the present disclosure. Method 300 may be implemented by the hardware and software of computing system 10 described above, or by other suitable hardware and software. At step 304 of FIG. 6A, the method 300 may include receiving a graph of service location nodes and edges representing a travel cost metric between the service location nodes, each service location node having an associated service weighting value indicating a size, weight, or number of one or more service items associated with each service location node. As indicated at 306, the service location nodes may represent locations at which a service is to be performed by the vehicle, in which the service may be delivery, pick-up, and maintenance. Further, as indicated at 308, the travel cost metric may be travel distance, travel time, carbon footprint, or travel cost. Finally, as indicated at 310 and described above, the service location nodes may further include delivery time windows.

At step 312, the method may further include, for each of a plurality of vehicles available to service the service locations, determining a vehicle capacity, and instantiating a route data structure configured to store an ordered list of service location nodes, ordered by travel order. As indicated at 314, the vehicle capacity may be in size, weight, or number of the items. Further, as indicated at 316, the route data structure may be an array of the service location nodes.

At step 318, the method may further include clustering the graph into a plurality of node clusters such that a total of the service weighting values of all service location nodes in each node cluster is less than or equal to a vehicle capacity of a respective vehicle of the plurality of vehicles. As indicated at 320, the graph may be clustered using a clustering algorithm that includes a loss function with a loss term for vehicle capacity. As indicated at 322, the loss function may further include a loss term for cut loss and a loss term for orthogonality loss among clusters. As indicated at 324, the graph may be a modified MinCutPool algorithm. Further, as indicated at 326, the number of node clusters may be less than or equal to the number of available vehicles.

Continuing with FIG. 6B, at step 328, the method may further include populating the ordered list of each route data structure with the service location nodes in a respective cluster. As indicated at 330, the initial population may be random or pseudorandom. At step 332, the method may include optimizing the ordered list of each route data structure to minimize a total travel cost metric of the plurality of vehicles. At step 334, the method may further include commencing or executing an annealing loop, and determining a new annealing temperature at each pass. At step 336, at each pass through the annealing loop, for each node cluster, the method may further include looping for a finite number of passes through a cluster optimization loop, and on each pass through the cluster optimization loop: inputting current state of respective clusters, route data structures, and annealing temperature to a reinforcement learning (RL) agent (step 338); at the RL agent, selecting stochastically a candidate route optimization action at each iteration of the loop according to a policy of the RL agent (step 340); at the RL agent, applying the selected route optimization action to the ordered list for one or more vehicles (step 342); at a Markov Chain Monte Carlo (MCMC) agent, evaluating the selected candidate route optimization action by calculating a total travel cost metric for the ordered list(s) (step 344); and updating the RL agent policy based on the evaluation of the selected candidate optimization action by the MCMC agent (step 346). At step 348, the method may further include, upon completion of the annealing loop, outputting the optimized ordered list in the route data structure for each vehicle.

It will be appreciated that the above-described systems and methods have the potential technical benefit of speeding up the overall computation for vehicle route optimization and generating a faster optimization, by avoiding computing the cost of routes that would exceed vehicle capacity, and causing the RL agent to learn an appropriate policy for selection of candidate actions to take during route optimization. Such approaches can bring the computation time down to a sufficient time frame to enable adoption of the above optimization techniques in real world scenarios such as scheduling daily deliveries of items from service depots. Optimized routes use less fuel, cost less, and take less time, providing benefits for the environment, businesses, and customers alike.

In some embodiments, the methods and processes described herein may be tied to a computing system of one or more computing devices. In particular, such methods and processes may be implemented as a computer-application program or service, an application-programming interface (API), a library, and/or other computer-program product.

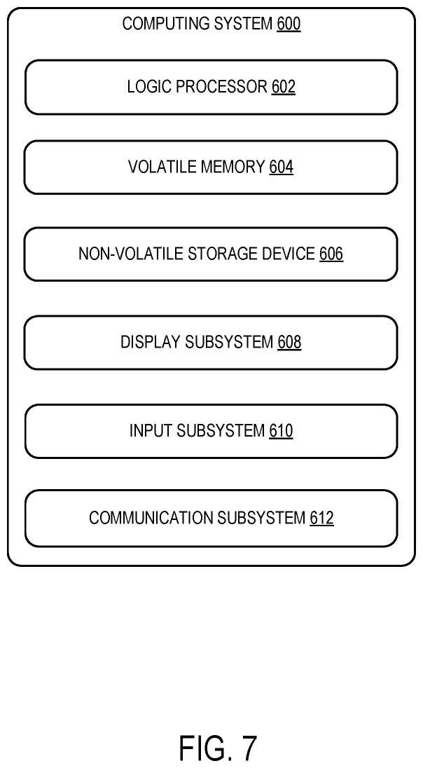

FIG. 7 schematically shows a non-limiting embodiment of a computing system 600 that can enact one or more of the methods and processes described above. Computing system 600 is shown in simplified form. Computing system 600 may embody the computing system 10 described above and illustrated in FIG. 1. Computing system 600 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 7.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

The following paragraphs discuss several aspects of the present disclosure. According to one aspect of the present disclosure, a computerized vehicle route optimization system is provided. The system may include a processor and associated memory storing instructions that when executed cause the processor to receive a graph of service location nodes and edges representing a travel cost metric between the service location nodes, each service location node having an associated service weighting value indicating a size, weight, or number of one or more service items associated with each service location node. The processor may be further configured to, for each of a plurality of vehicles available to service the service location nodes, determine a vehicle capacity, and instantiate a route data structure configured to store an ordered list of service location nodes, ordered by travel order. The processor may be further configured to cluster the graph into a plurality of node clusters such that a total of the service weighting values of all service location nodes in each node cluster is less than or equal to the vehicle capacity of a respective vehicle of the plurality of vehicles. The processor may be further configured to populate the ordered list of each route data structure with the service location nodes in a respective cluster. The processor may be further configured to optimize the ordered list of each route data structure to minimize a total travel cost metric of the plurality of vehicles, by, for each node cluster, looping for a finite number of passes through a loop, and on each of a plurality of passes through the loop: selecting a candidate route optimization action at each iteration of the loop according to a policy of a reinforcement learning (RL) agent; applying the selected route optimization action to the ordered list for one or more vehicles; evaluating the selected candidate route optimization action by calculating a total travel cost metric for the ordered list; and updating the policy based on the evaluation of the selected candidate route optimization action. The processor may be further configured to output the optimized ordered list in the route data structure for each vehicle.

According to this aspect, the service location nodes may represent locations at which a service is to be performed by the vehicle, in which the service is selected from the group consisting of delivery, pick-up, and maintenance.

According to this aspect, the travel cost metric may be selected from the group consisting of travel distance, travel time, carbon footprint, and travel cost.

According to this aspect, each service location node may further include an associated node parameter indicating a delivery time window within which one of the vehicles is to arrive to perform a service.

According to this aspect, the vehicle capacity may be based on size, weight, and/or number of the items.

According to this aspect, the graph may be clustered using a clustering algorithm that includes a loss function with a loss term for vehicle capacity

According to this aspect, the loss function of the clustering algorithm may further include a loss term for cut loss and a loss term for orthogonality loss among node clusters.

According to this aspect, the ordered lists may be initially populated with the service location nodes in a random or pseudorandom travel order.

According to this aspect, the processor may be further configured to implement a Markov Chain Monte Carlo (MCMC) agent configured to perform the evaluating of the selected candidate route optimization action from the RL agent based on an MCMC accept/reject policy, and to perform the updating of the RL agent policy based on the evaluation of the selected candidate route optimization action by sending a reward to the RL agent.

According to this aspect, the RL agent may be configured to, on each loop, receive a current state of the respective cluster and route data structure of the corresponding vehicle, and select the candidate route optimization action from among a predetermined set of candidate route optimization actions stochastically, based on a set of probabilities defined in the RL agent policy for each of the set of candidate route optimization actions for the state of each respective cluster and route data structure for each corresponding vehicle.

According to this aspect, the loop may be a cluster optimization loop, and the processor may be further configured to execute an annealing loop within which the cluster optimization loop is a subloop, and on each pass of the annealing loop: determine a value for an annealing temperature according to an annealing temperature function that trends lower over time, the MCMC agent being configured to conditionally accept the selected candidate route optimization actions with a higher evaluated cost than a previous pass through the cluster optimization loop more readily at higher annealing temperatures and less readily at lower annealing temperatures; and perform the cluster optimization loop for each cluster and the route data structure of each associated vehicle at the value for the annealing temperature, such that the RL agent learns a policy that considers each value of the annealing temperature.

According to another aspect of the present disclosure, a computerized method is provided. The computerized method may include receiving a graph of service location nodes and edges representing a travel cost metric between the service location nodes, in which each service location node has an associated service weighting value indicating a size, weight, or number of one or more service items associated with each service location node. The computerized method may further include, for each of a plurality of vehicles available to service the service locations, determining a vehicle capacity, and instantiating a route data structure configured to store an ordered list of service location nodes, ordered by travel order. The computerized method may further include clustering the graph into a plurality of node clusters such that a total of the service weighting values of all service location nodes in each node cluster is less than or equal to a vehicle capacity of a respective vehicle of the plurality of vehicles. The computerized method may further include populating the ordered list of each route data structure with the service location nodes in a respective cluster. The computerized method may further include optimizing the ordered list of each route data structure to minimize a total travel cost metric of the plurality of vehicles, by, for each node cluster, looping for a finite number of passes through a loop, and on each of a plurality of passes through the loop: selecting a candidate route optimization action at each iteration of the loop according to a policy of a reinforcement learning (RL) agent; applying the selected route optimization action to the ordered list for one or more vehicles; evaluating the selected candidate route optimization action by calculating a total travel cost metric for the ordered list; and updating the policy based on the evaluation of the selected candidate route optimization action. The computerized method may further include outputting the optimized ordered list in the route data structure for each vehicle.

According to this aspect, the service location nodes may represent locations at which a service is to be performed by the vehicle, in which the service is selected from the group consisting of delivery, pick-up, and maintenance.

According to this aspect, the travel cost metric may be selected from the group consisting of travel distance, travel time, carbon footprint, and travel cost.

According to this aspect, the graph may be clustered using a clustering algorithm that includes a loss function with a loss term for vehicle capacity.

According to this aspect, the loss function of the clustering algorithm may further include a loss term for cut loss and a loss term for orthogonality loss among node clusters.

According to this aspect, the computerized method may further include performing, via a Markov Chain Monte Carlo (MCMC) agent, the evaluating of the selected candidate route optimization action from the RL agent based on an MCMC accept/reject policy, and performing the updating of the RL agent policy based on the evaluation of the selected candidate route optimization action by sending a reward to the RL agent.

According to this aspect, the computerized method may further include, on each loop, receiving, via the RL agent, a current state of the respective cluster and route data structure of the corresponding vehicle, and selecting, via the RL agent, the candidate route optimization action from among a predetermined set of candidate route optimization actions stochastically, based on a set of probabilities defined in the RL agent policy for each of the set of candidate route optimization actions for the state of each respective cluster and route data structure for each corresponding vehicle.

According to this aspect, where the loop is a cluster optimization loop, the method may further include executing an annealing loop within which the cluster optimization loop is a subloop, and on each pass of the annealing loop: determining a value for an annealing temperature according to an annealing temperature function that trends lower over time, the MCMC agent being configured to conditionally accept the selected candidate route optimization actions with a higher evaluated cost than a previous pass through the cluster optimization loop more readily at higher annealing temperatures and less readily at lower annealing temperatures; and performing the cluster optimization loop for each cluster and the route data structure of each associated vehicle at the value for the annealing temperature, such that the RL agent learns a policy that considers each value of the annealing temperature.

According to another aspect of the present disclosure, a computerized vehicle route optimization system is provided. The system may include a processor and associated memory storing instructions that when executed cause the processor to receive a graph of service location nodes and edges representing a travel cost metric between the service location nodes, in which each service location node has an associated service weighting value indicating a size, weight, or number of one or more service items associated with each service location node. The processor may be further configured to, for each of a plurality of vehicles available to service the service locations, determine a vehicle capacity, and instantiate a route data structure configured to store an ordered list of service location nodes, ordered by travel order. The processor may be further configured to populate the ordered list of each route data structure with the service location nodes in the graph. The processor may be further configured to optimize the ordered list of each route data structure to minimize a total travel cost metric of the plurality of vehicles, by looping for a finite number of passes through a loop, and on each pass: selecting a candidate route optimization action at each iteration of the loop according to a policy of a reinforcement learning (RL) agent; applying the selected route optimization action to the ordered list for one or more vehicles; evaluating, via a Markov Chain Monte Carlo (MCMC) agent, the selected candidate route optimization action from the RL agent based on an MCMC accept/reject policy; and updating, via the MCMC agent, the RL agent policy based on the evaluation of the selected candidate route optimization action by sending a reward to the RL agent. The processor may be further configured to output the optimized ordered list in the route data structure for each vehicle.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computerized vehicle route optimization system, comprising:
a processor and associated memory storing instructions that when executed cause the processor to:
receive a graph of service location nodes and edges representing a travel cost metric between the service location nodes, each service location node having an associated service weighting value indicating a size, weight, or number of one or more service items associated with each service location node;
for each of a plurality of vehicles available to service the service location nodes, determine a vehicle capacity, and instantiate a route data structure configured to store an ordered list of service location nodes, ordered by travel order;
cluster the graph into a plurality of node clusters such that a total of the service weighting values of all service location nodes in each node cluster is less than or equal to the vehicle capacity of a respective vehicle of the plurality of vehicles;
populate the ordered list of each route data structure with the service location nodes in a respective cluster;
optimize the ordered list of each route data structure to minimize a total travel cost metric of the plurality of vehicles, by, for each node cluster, looping for a finite number of passes through a loop, and on each of a plurality of passes through the loop:
selecting a candidate route optimization action at each iteration of the loop according to a policy of a reinforcement learning (RL) agent;
applying the selected route optimization action to the ordered list for one or more vehicles;
evaluating the selected candidate route optimization action by calculating a total travel cost metric for the ordered list; and
updating the policy based on the evaluation of the selected candidate route optimization action; and
output the optimized ordered list in the route data structure for each vehicle.

2. The computerized vehicle route optimization system of claim 1, wherein the service location nodes represent locations at which a service is to be performed by the vehicle, the service being selected from the group consisting of delivery, pick-up, and maintenance.

3. The computerized vehicle route optimization system of claim 1, wherein the travel cost metric is selected from the group consisting of travel distance, travel time, carbon footprint, and travel cost.

4. The computerized vehicle route optimization system of claim 1, wherein each service location node further includes an associated node parameter indicating a delivery time window within which one of the vehicles is to arrive to perform a service.

5. The computerized vehicle route optimization system of claim 1, wherein the vehicle capacity is based on size, weight, and/or number of the items.

6. The computerized vehicle route optimization system of claim 1, wherein the graph is clustered using a clustering algorithm that includes a loss function with a loss term for vehicle capacity.

7. The computerized vehicle route optimization system of claim 6, wherein the loss function of the clustering algorithm further includes a loss term for cut loss and a loss term for orthogonality loss among node clusters.

8. The computerized vehicle route optimization system of claim 1, wherein the ordered lists are initially populated with the service location nodes in a random or pseudorandom travel order.

9. The computerized vehicle route optimization system of claim 1, wherein the processor is further configured to implement a Markov Chain Monte Carlo (MCMC) agent configured to perform the evaluating of the selected candidate route optimization action from the RL agent based on an MCMC accept/reject policy, and to perform the updating of the RL agent policy based on the evaluation of the selected candidate route optimization action by sending a reward to the RL agent.

10. The computerized vehicle route optimization system of claim 9, wherein the RL agent is configured to:
on each loop, receive a current state of the respective cluster and route data structure of the corresponding vehicle; and
select the candidate route optimization action from among a predetermined set of candidate route optimization actions stochastically, based on a set of probabilities defined in the RL agent policy for each of the set of candidate route optimization actions for the state of each respective cluster and route data structure for each corresponding vehicle.

11. The computerized vehicle route optimization system of claim 9, wherein the loop is a cluster optimization loop, and the processor is further configured to execute an annealing loop within which the cluster optimization loop is a subloop, and on each pass of the annealing loop:
determine a value for an annealing temperature according to an annealing temperature function that trends lower over time, the MCMC agent being configured to conditionally accept the selected candidate route optimization actions with a higher evaluated cost than a previous pass through the cluster optimization loop more readily at higher annealing temperatures and less readily at lower annealing temperatures; and
perform the cluster optimization loop for each cluster and the route data structure of each associated vehicle at the value for the annealing temperature, such that the RL agent learns a policy that considers each value of the annealing temperature.

12. A computerized method for vehicle route optimization, comprising:
receiving a graph of service location nodes and edges representing a travel cost metric between the service location nodes, each service location node having an associated service weighting value indicating a size, weight, or number of one or more service items associated with each service location node;
for each of a plurality of vehicles available to service the service locations, determining a vehicle capacity, and instantiating a route data structure configured to store an ordered list of service location nodes, ordered by travel order;
clustering the graph into a plurality of node clusters such that a total of the service weighting values of all service location nodes in each node cluster is less than or equal to a vehicle capacity of a respective vehicle of the plurality of vehicles;
populating the ordered list of each route data structure with the service location nodes in a respective cluster;
optimizing the ordered list of each route data structure to minimize a total travel cost metric of the plurality of vehicles, by, for each node cluster, looping for a finite number of passes through a loop, and on each of a plurality of passes through the loop:
selecting a candidate route optimization action at each iteration of the loop according to a policy of a reinforcement learning (RL) agent;
applying the selected route optimization action to the ordered list for one or more vehicles;
evaluating the selected candidate route optimization action by calculating a total travel cost metric for the ordered list; and
updating the policy based on the evaluation of the selected candidate route optimization action; and
outputting the optimized ordered list in the route data structure for each vehicle.

13. The method of claim 12, wherein the service location nodes represent locations at which a service is to be performed by the vehicle, the service being selected from the group consisting of delivery, pick-up, and maintenance.

14. The method of claim 12, wherein the travel cost metric is selected from the group consisting of travel distance, travel time, carbon footprint, and travel cost.

15. The method of claim 12, wherein the graph is clustered using a clustering algorithm that includes a loss function with a loss term for vehicle capacity.

16. The method of claim 12, wherein the loss function of the clustering algorithm further includes a loss term for cut loss and a loss term for orthogonality loss among node clusters.

17. The method of claim 12, further comprising:
performing, via a Markov Chain Monte Carlo (MCMC) agent, the evaluating of the selected candidate route optimization action from the RL agent based on an MCMC accept/reject policy, and performing the updating of the RL agent policy based on the evaluation of the selected candidate route optimization action by sending a reward to the RL agent.

18. The method of claim 17, further comprising:
on each loop, receiving, via the RL agent, a current state of the respective cluster and route data structure of the corresponding vehicle; and
selecting, via the RL agent, the candidate route optimization action from among a predetermined set of candidate route optimization actions stochastically, based on a set of probabilities defined in the RL agent policy for each of the set of candidate route optimization actions for the state of each respective cluster and route data structure for each corresponding vehicle.

19. The method of claim 17, wherein the loop is a cluster optimization loop, the method further comprising executing an annealing loop within which the cluster optimization loop is a subloop, and on each pass of the annealing loop:
determining a value for an annealing temperature according to an annealing temperature function that trends lower over time, the MCMC agent being configured to conditionally accept the selected candidate route optimization actions with a higher evaluated cost than a previous pass through the cluster optimization loop more readily at higher annealing temperatures and less readily at lower annealing temperatures; and
performing the cluster optimization loop for each cluster and the route data structure of each associated vehicle at the value for the annealing temperature, such that the RL agent learns a policy that considers each value of the annealing temperature.

20. A computerized vehicle route optimization system, comprising:
a processor and associated memory storing instructions that when executed cause the processor to:
receive a graph of service location nodes and edges representing a travel cost metric between the service location nodes, each service location node having an associated service weighting value indicating a size, weight, or number of one or more service items associated with each service location node;
for each of a plurality of vehicles available to service the service locations, determine a vehicle capacity, and instantiate a route data structure configured to store an ordered list of service location nodes, ordered by travel order;
populate the ordered list of each route data structure with the service location nodes in the graph;
optimize the ordered list of each route data structure to minimize a total travel cost metric of the plurality of vehicles, by looping for a finite number of passes through a loop, and on each pass:
selecting a candidate route optimization action at each iteration of the loop according to a policy of a reinforcement learning (RL) agent;
applying the selected route optimization action to the ordered list for one or more vehicles;
evaluating, via a Markov Chain Monte Carlo (MCMC) agent, the selected candidate route optimization action from the RL agent based on an MCMC accept/reject policy; and
updating, via the MCMC agent, the RL agent policy based on the evaluation of the selected candidate route optimization action by sending a reward to the RL agent; and
output the optimized ordered list in the route data structure for each vehicle.
